(19) United States
(12) Patent Application Publication
(10) Pub. No.: US 2019/0107262 A1
(43) Pub. Date: Apr. 11, 2019

(54) LIGHT DEVICE COMPRISING A SPOTLIGHT EQUIPPED WITH A SUPPORT AND WITH AT LEAST ONE LIGHT MODULE, ASSEMBLY OF AT LEAST TWO LIGHT DEVICES AND METHOD OF USE OF THE ASSEMBLY

(71) Applicant: AYRTON, Longjumeau (FR)

(72) Inventor: Yvan Peard, Antony (FR)

(21) Appl. No.: 16/088,808

(22) PCT Filed: Mar. 31, 2017
(86) PCT No.: PCT/FR2017/050754

§ 371 Date: Sep. 26, 2018

(30) Foreign Application Priority Data
Apr. 5, 2016 (FR) 1652997

(51) Int. Cl. F21S 6/00; F21V 21/30; F21V 21/15; F21V 23/04; F21S 10/06

(52) U.S. Cl. CPC F21S 6/00; F21V 21/30; F21Y 2115/10; F21V 23/0407; F21S 10/06; F21V 21/15

(57) ABSTRACT

The present invention concerns a light device comprising a spotlight equipped with a support and with at least one light module fixed on said support, said light module comprising at least one light source, such as a light-emitting diode (LED), the light module being adapted for producing a light beam intermittently, wherein the light device comprises a base for fixing said light device on a bearing surface and a bracket for fixing the spotlight onto said base.

### FIELD OF INVENTION

The present invention concerns a light device equipped with a spotlight, said spotlight comprising a support and at least one light module adapted for producing a light beam and comprising at least one light source, such as a light-emitting diode (LED) and an optical element, such as a lens.

### STATE OF THE ART

Light devices are already known in the state of the art. As a general rule, a light device comprises a base and a spotlight forming an element articulated or pivoting in relation to said base. The base is used, for example, to fix the light devices on a bearing surface such as a wall, a ceiling or also a structure, adapted to enable said light devices to be visible, but also to light a space around said light devices. The spotlight comprises multiple light sources capable of emitting light beams.

If the light device is installed using the base, the spotlight can pivot in relation to this base in order to adjust the position of said spotlight in relation to said base and thereby determine the direction in which the light beams are emitted.

In the field of show business, and more particularly plays and musical shows, use of light devices represents a substantial part of the decor, thereby making it possible to generate particular light effects. Light devices are used to supplement the visual image offered to the spectators. During normal use of these light devices, it is possible to materialise the light beams thanks to a “mist” type smoke. This mist forms the medium on which the various light beams are rendered visible to the spectators.

In the field of show business, there is a constant need to improve existing systems and provide users with greater freedom to manipulate the spotlights in order to create innovative special effects.

The aim of the present invention consists in presenting a light device comprising a light module adapted for producing a light beam intermittently.

### OBJECT OF THE INVENTION

The object of the present invention consists in proposing a light device comprising a spotlight equipped with a support and with at least one light module fixed on said support, said light module comprising at least one light source, such as a light -emitting diode (LED), the light module being adapted for producing a light beam intermittently, wherein the stroboscope comprises a base for fixing said stroboscope on a bearing surface and a bracket for fixing the spotlight onto said base

A first advantage of this characteristic lies in the fact that the light device can be used as a stroboscope wherein the spotlight is adapted for pivoting in relation to the base thanks to the bracket.

More particularly, the spotlight is fixed to said bracket in a first rotation axis, the bracket being fixed to the base in a second rotation axis, the first and the second rotation axes being essentially perpendicular to each other, preferably perpendicular to each other.

More particularly, the first and the second rotation axes are adapted to enable unlimited rotation respectively of the spotlight in relation to the bracket and of the bracket in relation to the base.

More particularly, the spotlight comprises multiple light modules.

More particularly, the light modules are positioned in a grid shape comprising at least one row and at least one column.

More particularly, each light module comprises multiple light sources, such as multiple light-emitting diodes (LEDs).

More particularly, the light sources are positioned in a grid shape comprising at least one row and at least one column.

More particularly, each light module is adapted for receiving electronic control signals to adjust the illumination duration, illumination period and illumination intensity of the light source.

A second object of the invention concerns an assembly comprising at least a first and a second light device according to the characteristics described above, wherein the spotlights of said light devices are positioned to form an optical surface comprising multiple optical zones.

A third object of the invention concerns a method of use of a final image to produce electronic control signals, for the assembly according to the characteristics described above, said method comprising the following steps:
select an electronic input signal representative of a final image occupying a final surface, said final image being composed of multiple intermediate images, each intermediate image occupying an intermediate surface and being associated with first parameters,
determine a relationship of correspondence between each intermediate surface and each optical zone of the optical surface in order to generate, for each optical zone, second parameters representative of each intermediate image,
generate electronic control signals comprising the second parameters,
transmit the electronic control signals to the assembly to enable said assembly to produce multiple light beams associated with the final image.

### BRIEF DESCRIPTION OF DRAWINGS

The aim, object and characteristics of the invention will appear more clearly upon reading the description below drawn up with reference to the figures wherein:

FIG. 1 represents a first embodiment of a light device according to the invention,

FIG. 2 shows a side view of the light device according to FIG. 1,

FIG. 3 represents a perspective view of the light device according to FIG. 2,

FIG. 4 shows the rear face of the light device according to FIGS. 1, 2 and 3,

FIG. 5 represents an assembly of light devices according to the invention,

FIG. 6 shows an example of use of the assembly of light devices according to FIG. 5,

FIG. 7 represents the assembly of light devices according to FIG. 6, after rotation of the various spotlights of the light devices in said assembly,

FIG. 8 shows the light device according to FIG. 1 comprising light sources positioned on the spotlight of the light device, according to a specific configuration,

FIG. 9 shows a second embodiment of a light device according to the invention,

FIGS. 10a, 10b and 10c represent three alternative embodiments relating to the creation of a pixel on the front face of a spotlight of a light device according to the invention,

FIGS. 11a, 11b, 11c and 11d show four light devices according to the invention each presenting an alternative configuration of pixels,

FIG. 12 represents another embodiment making it possible to use a pixel on the front face of the spotlight of the light device according to the invention,

FIG. 13 shows, schematically, the parameters available intended for illuminating the various pixels on the front face of the spotlight of the light device according to the invention.

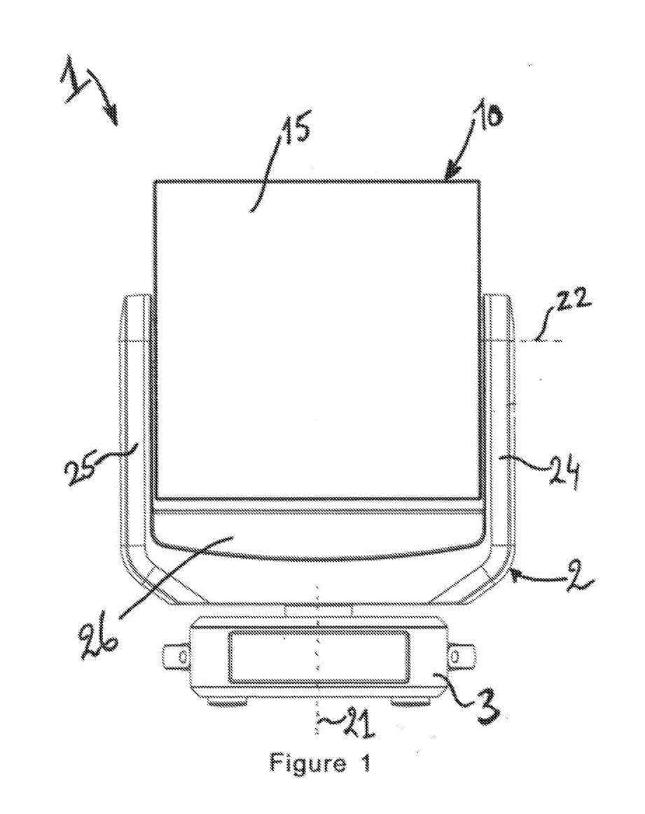

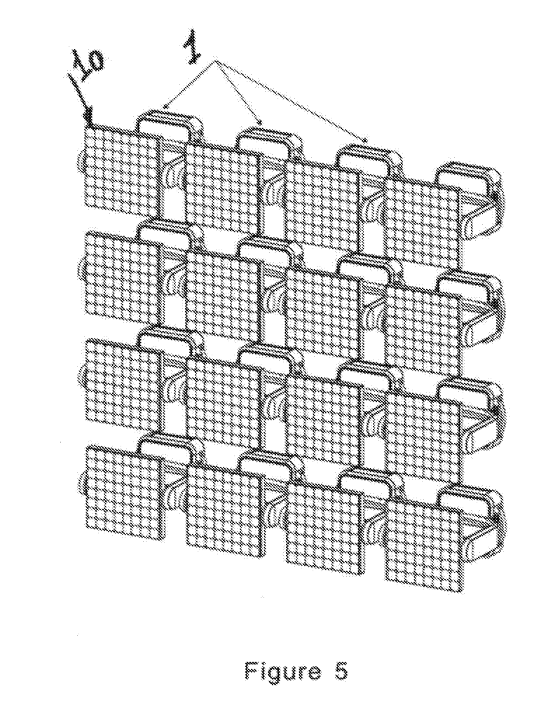

FIG. 1 represents a first embodiment of a light device 1 according to the invention. The light device 1 comprises a spotlight 10 connected to a bracket 2 comprising side arms 24, 25 and a bottom part 26. As shown in FIGS. 1 to 5, the spotlight 10 is fixed on the bracket 2 thus enabling the rotation of the spotlight 10 around a rotation axis 22 in relation to the bracket 2. The light device 1 comprises means making it possible to pivot the spotlight in relation to the bracket 2, said bracket 2 comprising among other things a motor and a belt. As illustrated in FIG. 5, and according to a conventional use of the light device 1, the base 3 and the bracket 2 are positioned behind the rear face of the spotlight 10. The means enabling the rotation of the spotlight 10 in relation to the bracket 2 can be positioned in the bottom part 26 of said bracket 2 so that the thin side arms 24, 25 are situated on the sides of the spotlight 10.

According to the invention, the connection means enabling the rotation of the spotlight 10 around the rotation axis 22 in relation to the bracket 2 are adapted so that said rotation can be unlimited, from 0° to 360°, and beyond, and in both rotation directions of the spotlight 10 in relation to the bracket 2. Similarly, the bracket 2 is fixed with connection means on the base 3 so that the bracket 2 is rotationally mobile around a rotation axis 21 in relation to the base 3. The connection means between said bracket 2 and said base 3 are adapted to enable unlimited rotation, from 0° to 360° and beyond, in both rotation directions around said rotation axis 21.

The light device 1 according to the invention is characterised in that the front face 15 of the spotlight 10 comprises multiple light sources adapted for producing light intermittently. As the light is produced intermittently, the light device 1 according to the invention can be used as a stroboscope. The various possibilities for positioning the light sources on the front face 15 of the spotlight 10 are described below and illustrated in FIGS. 5, 10a, 10b, 10c, 11a, 11 b, 11c and 11d.

A first advantage of the light device 1 as represented in FIG. 1 lies in the fact that the stroboscope obtained is a spotlight 10 comprising light sources adapted for intermittent illumination. Said spotlight 10 can be oriented in a position set by the user using a combination of rotations around the rotation axis 21 and around the rotation axis 22 essentially perpendicular to each other, preferably perpendicular. A stroboscope, obtained with the aid of set rotations around the rotation axes 21 and 22, can, simultaneously, produce light intermittently and be oriented so as to diffuse the light in a direction set by the user. The light device 1 according to FIG. 1 is particularly adapted for use within an assembly comprising multiple light devices 1. This characteristic is described below with reference to FIGS. 5, 6 and 7.

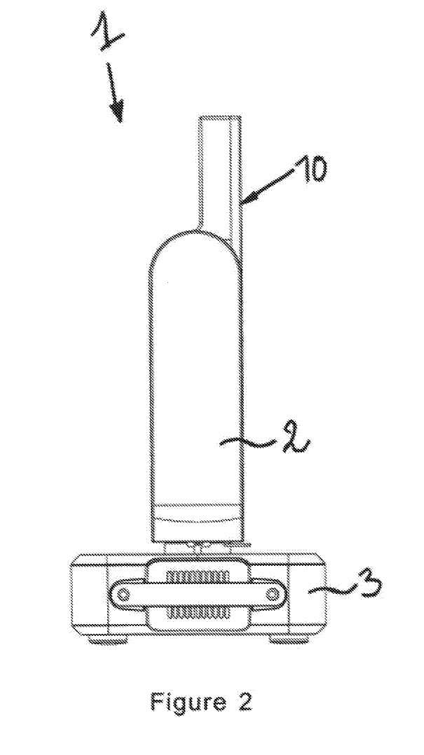

FIG. 2 shows a side view of the light device 1 according to FIG. 1. FIG. 2 also illustrates the fixing of the bracket 2 on the base 3 as well as the shape of the spotlight 10 connected to the bracket 2.

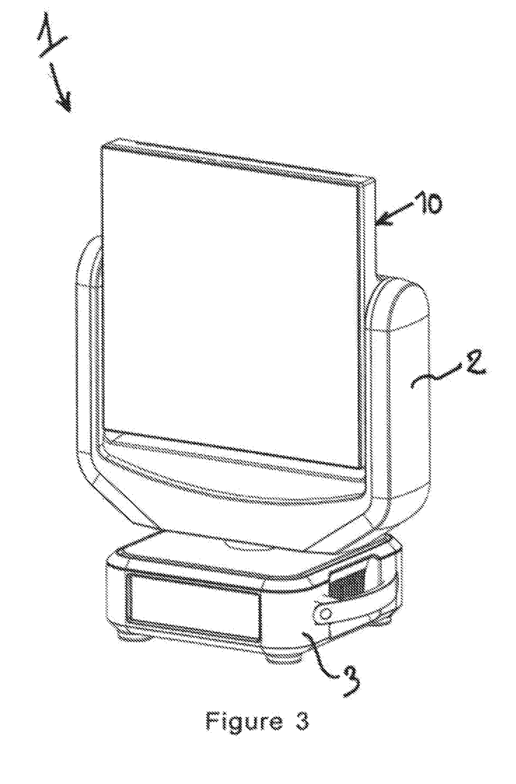

FIG. 3 represents a perspective view of the light device 1 according to FIGS. 1 and 2.

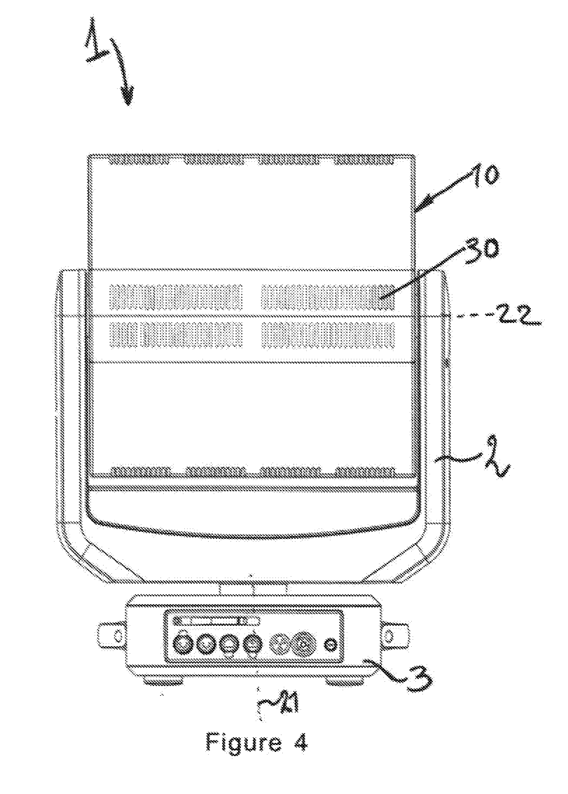

FIG. 4 shows the rear face of the spotlight 10. FIG. 4 also represents the spotlight 10 comprising multiple grilles 30 enabling air exchange between the interior and exterior of the spotlight 10. Thanks to such an air exchange, the heat generated inside the spotlight 10 during its use can be dispersed into the environment in which the light device 1 is used. FIG. 4 shows the base 3 comprising multiple connections. The base 3 can thus be connected to an electrical energy source to enable the operation of the light device 1. The base 3 is also adapted for being connected to a control device and receiving electronic control signals optimising the operation of the light device 1. The electronic control signals comprise, in particular, signals relating to the rotation of the spotlight 1 around the rotation axis 22 in relation to the bracket 2 and to the rotation of the bracket 2 around the rotation axis 21 in relation to the base 3, said rotations being set by the user.

FIG. 5 represents a mode of use of an assembly of light devices 1 according to the invention. The various light devices 1 are positioned to form together a grid comprising four rows and four columns. The spotlights 10 of the various light devices 1 form together an optical surface offering light effects obtained thanks to the various light devices 1 positioned on the front faces of the various spotlights 10 of the light devices 1.

As illustrated in FIG. 5, each spotlight 10 comprises a set quantity of pixels on its front face, each pixel occupying a surface referred to hereafter as the optical zone. Thus, the optical surface is composed of multiple optical zones. According to the example in FIG. 5, each spotlight 10 has a total of 64 pixels (8×8) positioned on its front face.

According to the present description, the term “pixel” refers to a light source or multiple light sources, which independently of the other pixels, can receive information to diffuse a light beam intermittently. In other words, each light device 1 according to FIG. 5 is capable of operating as an assembly of 64 stroboscopes.

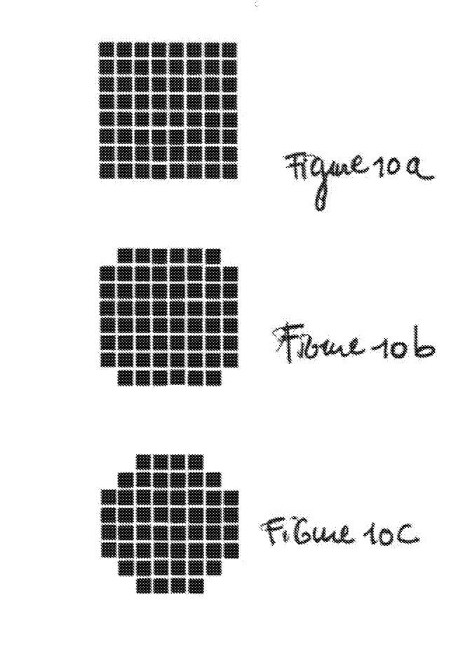

FIGS. 10a, 10b and 10c illustrate various examples making it possible to create a pixel for a spotlight 10 of a light device 1 according to the invention. According to the example shown in FIG. 10a, a single pixel comprises a grid of 8×8 light-emitting diodes (LEDs). Said light-emitting diodes (LEDs) intended for use within the light device 1 according to the invention are selected so as to provide optimal efficiency. In theory, it is possible to select any type of light-emitting diode (LED) suitable for forming the front face of a spotlight 10 of a light device 1 according to the invention.

Generally speaking, light-emitting diodes (LEDs) producing a white coloured light are favoured for use within a stroboscope.

Thus, it is possible to obtain, according to FIG. 5, a light device 1 which comprises 8×8 pixels on the front face of the spotlight 10, where, in combination with FIG. 10a, each pixel comprises a grid of 8×8 light-emitting diodes (LEDs). Therefore, such a spotlight 10 comprises one pixel containing 4096 (64×64) light-emitting diodes (LEDs) on its front face.

FIG. 10b represents an alternative shape of a pixel comprising an assembly of 60 light-emitting diodes (LEDs). As illustrated in FIG. 10b, the four pixels forming the corners have been removed. The pixel thus obtained makes it possible advantageously to have a space available between four adjacent pixels of this type. The space available is useful to the manufacturer of the spotlight 10 according to the invention. FIG. 10c illustrates an alternative example making it possible to obtain an essentially circle-shaped pixel presenting in total 52 light-emitting diodes (LEDs).

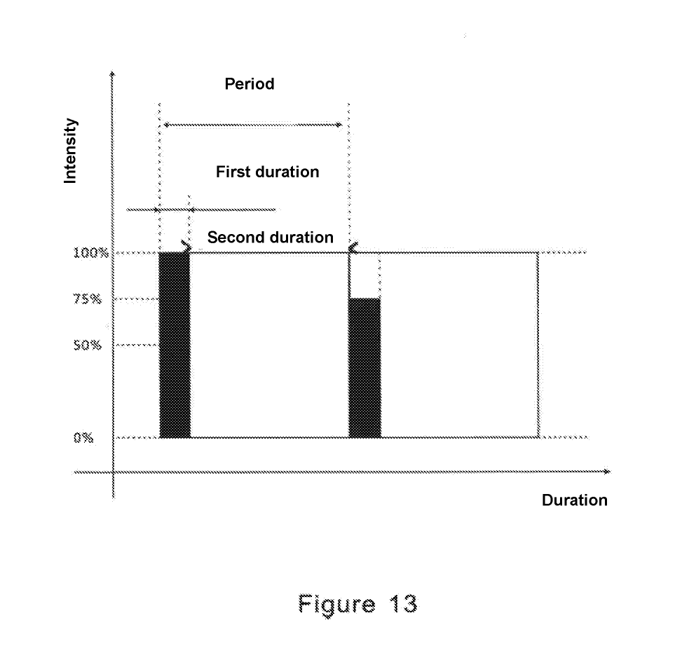

Thus the user has the possibility of using a combination of various types of pixel according to the user's preferences. As shown in FIG. 5, the optical surface created by the assembly of the spotlights 10 of the various adjacent light devices 1 makes it possible to obtain specific light effects. Each pixel can receive control signals making it possible to adjust its illumination. Said control signals intended for adjusting the illumination of a pixel comprise three illumination parameters. The three parameters and their mutual relationship are schematically represented in FIG. 13. One of the parameters is the intensity of light produced for said pixel. By way of example, said intensity can vary between 50%, 75% and 10% or any other intensity selected by the user depending on their requirements. The illumination intensity of a pixel is represented in the y-axis of the diagram represented in FIG. 13. Another of the illumination parameters of an individual pixel is the illumination duration. In FIG. 13, the illumination duration is represented in the x-axis. The illumination duration of a pixel can vary as a function of the use of the light device 1 on which said pixel is positioned. Another of the illumination parameters is the illumination period of the pixel. The illumination frequency of the pixel determines a defined time period comprising a first duration during which the pixel is illuminated and a second duration during which said pixel is not illuminated.

If the first duration is less than the illumination period, the pixel is illuminated intermittently via a flash. If the first duration is equal to or greater than the illumination period, the pixel is illuminated continuously.

According to the invention, each pixel positioned on the front face of a spotlight 10 of the light device 1 according to the invention is capable of receiving control signals individually. Thus, the assembly of pixels on a spotlight 10, or the assembly of spotlights 10 in an assembly as shown in FIG. 5, can generate specific light effects, by illuminating the various pixels on the various spotlights differently.

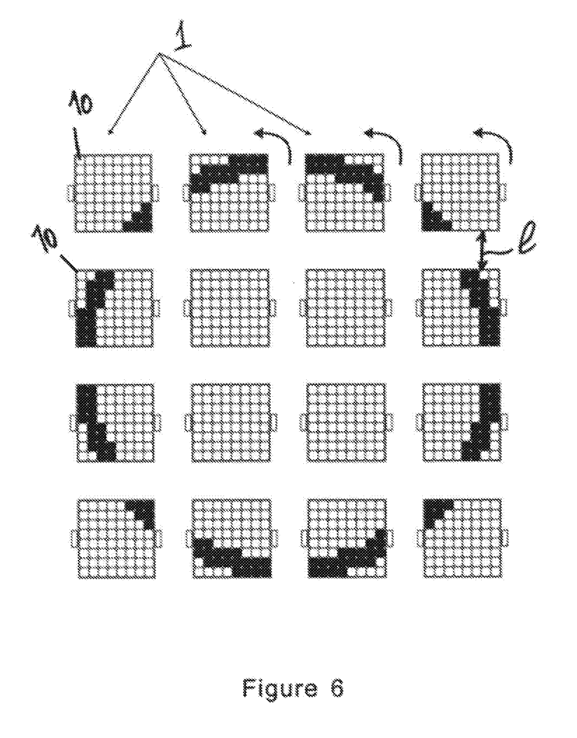

A first example of use of a light device assembly 1 according to the invention is shown in FIG. 6. Various light modules 1 are represented in FIG. 6, on which only certain pixels are illuminated. The assembly of spotlights 10 of the various light devices 1, as shown in FIG. 6, represents a specific light effect. According to this example, the various spotlights 10 represent together an essentially circular shape. The various pixels of the spotlights 10 of the light devices 1 illustrated in FIG. 6 produce a light of essentially identical colour.

According to the invention, it is possible to use a final image for the purpose of producing control signals intended for the various pixels positioned on the spotlight 10 of the light devices 1. The principal aim of using a final image is not to display said final image. Indeed, the aim is to enable coherent use of the various spotlights 10 of the adjacent light devices 1 which form the optical surface. In other words, the user is seeking to obtain a light effect which is coherent and visually pleasing to view using an assembly of spotlights 10. According to an embodiment of the invention, said final image can be used to produce electronic signals, as described in the method below.

In a first step, an input electronic signal representative of a final image occupying a final surface is selected. The aim of using said final image consists in establishing a link or a correspondence relationship between said final surface and the optical surface obtained thanks to an assembly of spotlights 10. A final image can be a single image or a sequence of images making it possible to create a movement. In other words, the electronic input signal can comprise a video signal.

The final image is composed of multiple intermediate images, each intermediate image occupying an intermediate surface and being associated with first parameters. The final image is intended to produce electronic signals for a set number of pixels positioned on the various spotlights 10. The division of the final image into intermediate images makes it possible to establish a correspondence relationship which can be established between each optical zone of each pixel and each intermediate zone of each intermediate image, within said multiple intermediate images. As shown in FIG. 6, there is a necessary free space between the various adjacent spotlights 10 to enable the various spotlights 10 to pivot without the ends of said spotlights 10 being in contact.

When creating a correspondence relationship between a final image and the optical surface created by the spotlights 10, the distance “I” between two adjacent spotlights 10 is taken into consideration. According to the example illustrated in FIG. 6, the user can reconstitute a circle-shaped final image despite the absence of pixels in the free space between the adjacent spotlights 10. Indeed, the human eye is capable of reconstituting the final image given the proximity of the spotlights 10.

Should the final image comprise a colour image, each intermediate image has its own colour. Thus, the first parameters designate the colour which can be represented by a set quantity of blue, red, or green. If the intermediate image is rather blue, the first parameter indicating the percentage of blue is greater than the other two first parameters. If the image is rather red, the first parameter representing red is greater than the other two first parameters. Thus, for each intermediate image, three different first parameters are available. In a following step of the method according to the invention, a correspondence relationship is determined between each intermediate surface and each optical zone of the optical surface, for example, each pixel of the optical surface. This correspondence relationship is necessary to generate, for each optical zone, second parameters representative of each intermediate image. The second parameters comprise the illumination intensity, duration and period of the pixels as described above with reference to FIG. 13. In a following step of the method according to the invention, electronic control signals comprising the second parameters are generated. The electronic control signals available for each pixel can control the illumination intensity, duration and period of the various pixels. If the control signals are available for the various light devices 1, within an assembly as represented in FIG. 6, said electronic control signals are transmitted, in a final step, to the assembly to enable emission of multiple light beams associated with the final image.

An advantage of the method for generating electronic control signals consists in obtaining a representation of a quantity of coherent data. Coherence in the electronic control signals obtained is also observed. Thus, the data coherence character of the final image is retained during emission of the light beams. Use of a final image can help the user of the light device 1 according to the invention to obtain coherent, specific and aesthetic light effects.

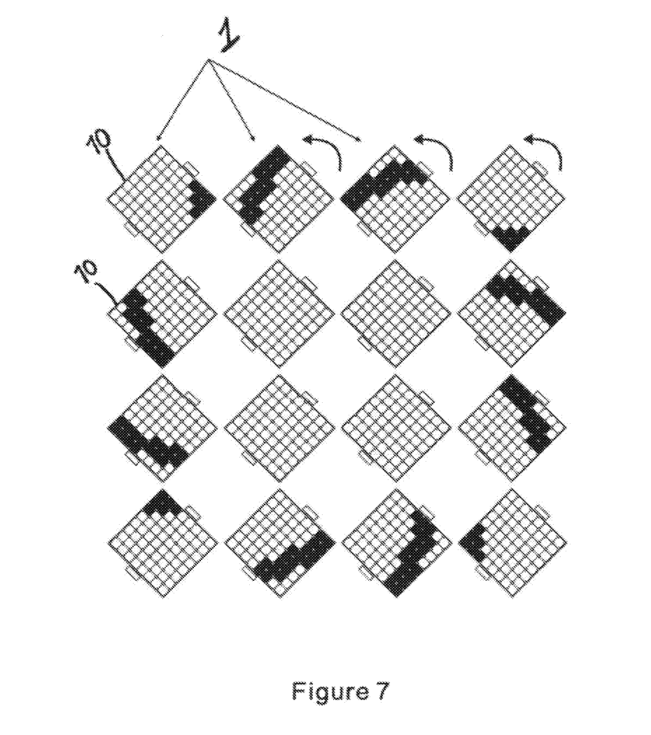

Beside use of an assembly as shown in FIG. 6, other control signals offer the system user greater freedom of use. This possibility is shown schematically in FIG. 7. Based on an image represented on the various spotlights 10 with the aid of the rotation axes 21, 22 as described with reference to FIGS. 1 to 4, the various spotlights 10 pivot in relation to the adjacent spotlights 10 in order to obtain an additional light effect.

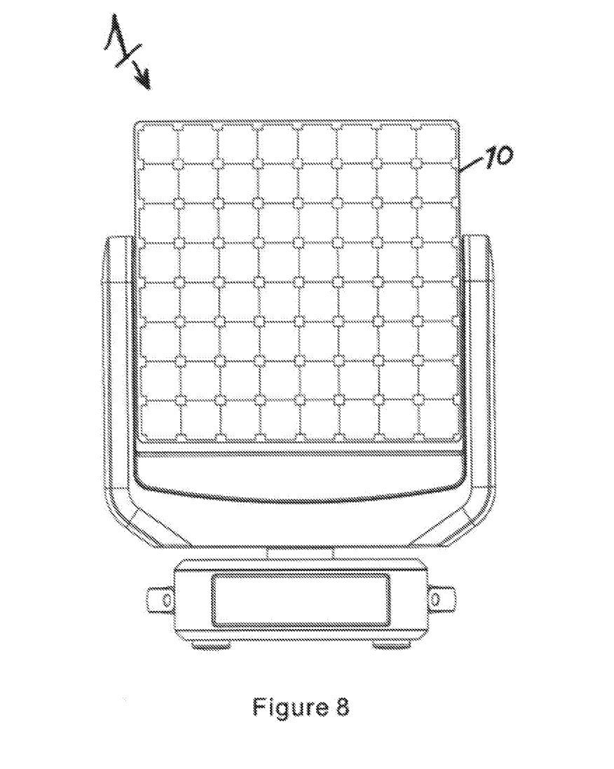

FIG. 8 represents a light device 1 according to the invention comprising a spotlight 10 on the front face of which are positioned 64 pixels of the type represented in FIG. 10b. In other words, according to the example illustrated in FIG. 8, an assembly of 3840 light-emitting diodes (64×60) (LEDs) is installed on the front face of the spotlight 10.

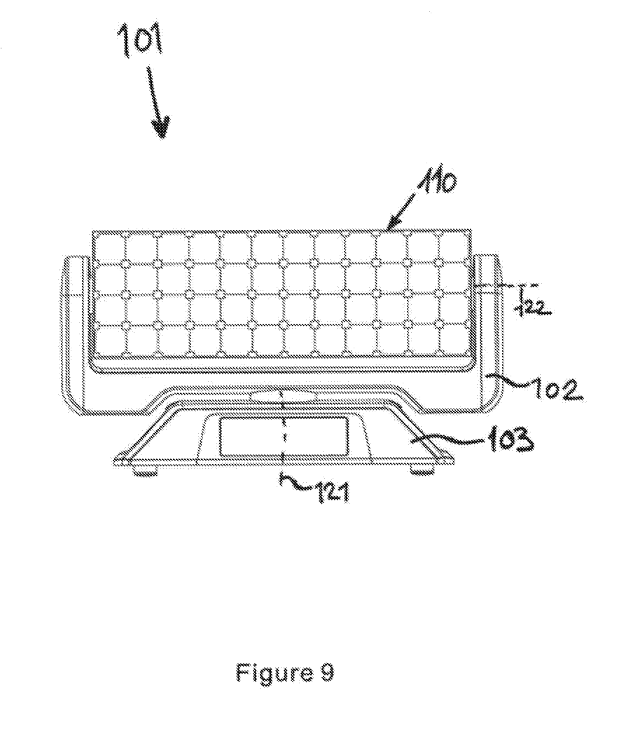

FIG. 9 shows a second embodiment 101 of the light device according to the invention. The light device 101 according to FIG. 9 comprises a spotlight 110 fixed to a bracket 102 with the aid of a rotation axis 122. The bracket 102 is itself fixed to a base 103 with the aid of a rotation axis 121. The base 103 is, like the base 3 as shown in FIGS. 1 to 3 of the light device 1, adapted for fixing the light device 101 on a bearing surface such as a support. According to FIG. 9, the spotlight 110 comprises a quantity of pixels positioned on the front face of the spotlight 110 in order to form a grid comprising four rows and twelve columns. The 4×12 pixels positioned on the front face of the spotlight 110 present a shape as shown in FIG. 10b. Therefore the spotlight 110 according to FIG. 9 comprises a total of 2880 (4×12×60) pixels on its front face.

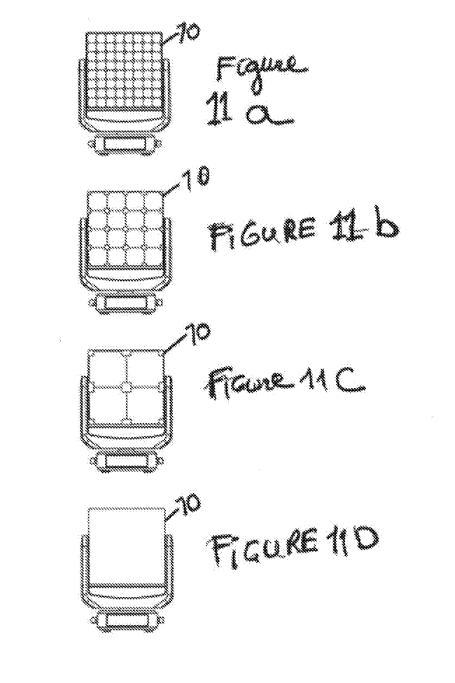

The various pixels, for example the pixels positioned on the front face of the spotlight 10 as represented in FIG. 8, can receive electronic signals making it possible to control their operation independently. This mode of use of the various pixels is represented schematically in FIG. 11a. It is possible to group together the various pixels on the front face of the spotlight 10 so as to obtain four rows and four columns, each group representing four pixels. This mode of use is illustrated, schematically, in FIG. 11b. As shown in FIG. 11b, 16 pixels can receive instructions. Alternatively, the pixels can be grouped into four groups of pixels, each group presenting a total of 16 pixels. Therefore the four groups can receive electronic control signals. This option is shown in FIG. 11c. FIG. 11d illustrates the possibility of obtaining a single pixel occupying the whole of the front face of the spotlight 10. The various modes of use 11a, 11b, 11c and 11d of the spotlight 10 of the light device 1 according to the invention concern solely the available pixel resolution options making it possible to obtain light effects. As a general rule, the further the spectator is from the optical surface of the spotlight 10, the more minimal the resolution to enable the spectator to enjoy the light effects.

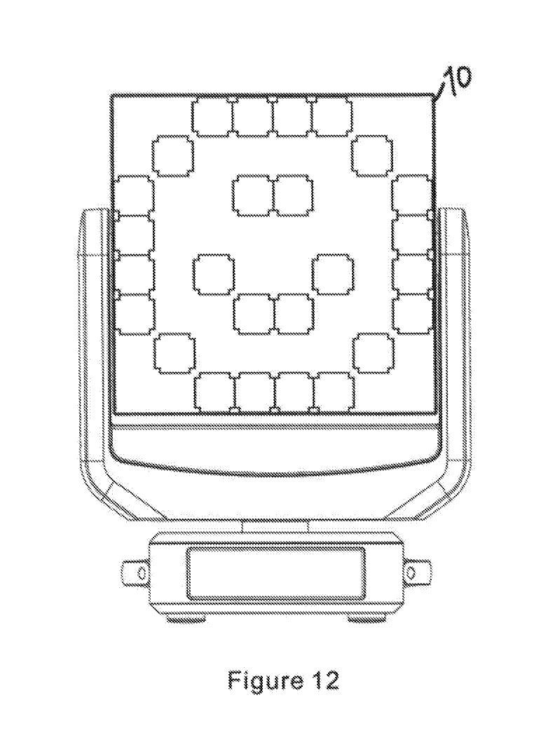

FIG. 12 represents an embodiment using part of the available surface on the front face of a spotlight 10 to position pixels. The pixels used on said front face of the spotlight 10 according to FIG. 12 are of the type shown in FIG. 10b.

1. A stroboscope (1, 101) comprising a spotlight (10, 110) equipped with a support and with multiple light modules fixed on said support, said light modules being positioned in the shape of a grid comprising at least one row and at least one column, each light module comprising multiple light sources, such as multiple light-emitting diodes (LEDs), the light sources being positioned in the shape of a grid comprising at least one row and at least one column, said light modules being adapted for producing light intermittently, wherein the stroboscope (1, 101) comprises a base (3, 103) for fixing said stroboscope (1, 101) on a bearing surface and a bracket (2, 102) for fixing the spotlight (10, 110) onto said base (3, 103).

2. The stroboscope (1, 101) according to claim 1, wherein the spotlight (10, 110) is fixed to said bracket (2, 102) in a first rotation axis (22, 122), the bracket (2, 102) being fixed to the base (3, 103) in a second rotation axis (21, 121), the first (22, 122) and the second (21, 121) rotation axes being essentially perpendicular to each other, preferably perpendicular to each other.

3. The stroboscope (1, 101) according to claim 2, wherein the first (22, 122) and the second (21, 121) rotation axes are adapted to enable unlimited rotation respectively of the spotlight (10, 110) in relation to the bracket (2, 102) and of the bracket (2, 102) in relation to the base (3, 103).

4. The stroboscope (1, 101) according to claim 1, wherein each light module is adapted for receiving electronic control signals to adjust the illumination duration, illumination period and illumination intensity of the light source.

5. The stroboscope (1, 101) according to claim 1, wherein for each light module, the light sources forming the corners of said light sources grid have been removed to enable adjacent modules to demarcate a free space.

6. An assembly comprising at least a first and a second stroboscope (1, 101) according to claim 1, wherein the spotlights (10, 110) of said stroboscopes (1, 101) are positioned to form an optical surface comprising multiple optical zones.

7. A method of use of a final image to produce electronic control signals, for the assembly according to claim 6, said method comprising the following steps:
select an electronic input signal representative of a final image occupying a final surface, said final image being composed of multiple intermediate images, each intermediate image occupying an intermediate surface and being associated with first parameters,
determine a relationship of correspondence between each intermediate surface and each optical zone of the optical surface in order to generate, for each optical zone, second parameters representative of each intermediate image,
generate electronic control signals comprising the second parameters,
transmit the electronic control signals to the assembly to enable said assembly to produce multiple light beams associated with the final image.
